(19) United States
(12) Patent Application Publication
(10) Pub. No.: US 2023/0151564 A1
(43) Pub. Date: May 18, 2023

(54) AGGREGATE AND EMULSION DISPENSING PROCESS FOR POTHOLE PATCHER VEHICLE

(71) Applicant: Bergkamp Incorporated, Salina, KS (US)

(72) Inventors: Jordan Reisinger, Salina, KS (US); Lesley Todd Hays, Waco, TX (US)

(21) Appl. No.: 17/529,191

(22) Filed: Nov. 17, 2021

(51) Int. Cl. E01C 23/09; B05B 12/08; B05B 12/14

(52) U.S. Cl. CPC E01C 23/098; B05B 12/085; B05B 12/1418; E01C 11/005

(57) ABSTRACT

A pothole patcher vehicle is configured to discharge a calibrated flow of a patching material. The pothole patcher vehicle broadly includes a material conveying device and a processor. The material conveying device includes a motor and is configured to supply patching material to a discharge spout. The processor is operably coupled to the material conveying device.

### BACKGROUND

### 1. Field

The present invention relates generally to paving equipment. More specifically, embodiments of the present invention concern a pothole spray patching vehicle configured to repair a pothole in a paved surface.

### 2. Discussion of Prior Art

Various types of conventional paving equipment are commonly used to repair a paved surface, such as a road or parking area. Prior art pothole patching vehicles are used to discharge asphalt emulsion and aggregate for repairing potholes in the paved surface. Known spray patching vehicles include an emulsion system and an aggregate system that facilitate discharge of emulsion and aggregate, respectively, into a pothole while permitting an operator to remain in the vehicle during the repair process.

However, conventional pavement patching equipment is known to be deficient due to several disadvantages. For instance, consistent repair quality is difficult to achieve with the use of known patching devices. In particular, the systems of conventional spray patching equipment used to discharge emulsion and aggregate are prone to producing an inconsistent discharge of spray patching material (e.g., due to inconsistent discharge rates and/or discharge times). As a result, emulsion and aggregate may not be uniformly distributed within a pothole, and the relative amounts of emulsion and aggregate may change drastically from one repair site to the next.

This background discussion is intended to provide information related to the present invention which is not necessarily prior art.

### SUMMARY

The following brief summary is provided to indicate the nature of the subject matter disclosed herein. While certain aspects of the present invention are described below, the summary is not intended to limit the scope of the present invention.

Embodiments of the present invention provide a pothole patching vehicle that does not suffer from the problems and limitations of prior art devices, including those set forth above.

A first aspect of the present invention concerns a pothole spray patcher vehicle configured to discharge a calibrated flow of a spray patching material. The pothole spray patcher vehicle broadly includes a material conveying device and a processor. The material conveying device includes a motor and is configured to supply spray patching material to a discharge spout. The processor is operably coupled to the material conveying device and is configured to determine a flow calibration coefficient by operating the conveying device to discharge an amount of spray patching material from the spout, recording the amount of spray patching material discharged, recording a device operational value associated with the amount of spray patching material discharged, and calculating the flow calibration coefficient based upon the recorded amount of spray patching material and the recorded device operational value; record a selected flow rate of spray patching material set by the user; calculate a device speed based upon the recorded selected flow rate and the calculated flow calibration coefficient; and operate the conveying device at the calculated device speed.

A second aspect of the present invention concerns a pothole spray patcher vehicle configured to set a desired mixture of dispensed spray patching materials. The pothole spray patcher vehicle broadly includes first and second material conveying devices and a processor. The first material conveying device is operable to supply a flow of first spray patching material. The second material conveying device is operable to supply a flow of second spray patching material. The processor is operably coupled to the material conveying devices and is configured to record a selected flow rate of the first spray patching material set by the user; record a selected ratio of the first spray patching material flow and the second spray patching material flow set by the user; and calculate a flow rate of the second spray patching material based upon the recorded first spray patching material flow rate and the recorded ratio.

A third aspect of the present invention concerns a pothole patcher vehicle configured to supply a desired ratio of dispensed patching materials. The pothole patcher vehicle broadly includes first and second material conveying devices and a processor. The first material conveying device is operable to supply a flow of first patching material. The second material conveying device is operable to supply a flow of second patching material. The processor is operably coupled to the material conveying devices and configured to record a flow rate of the first patching material set by the user; record a flow rate of the second patching material as set by the user or as determined by calculating the flow rate of the second patching material based upon the recorded first patching material flow rate and a recorded ratio set by the user; operate the first material conveying device to supply a flow rate of first patching material associated with the recorded flow rate of first patching material; and operate the second material conveying device to supply a flow rate of second patching material associated with the recorded flow rate of second patching material.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a front perspective view of a spray patcher vehicle constructed in accordance with a preferred embodiment of the present invention, with the vehicle including a powered chassis, spray boom assembly, aggregate system, emulsion system, dispensing head, and control station;

FIG. 2 is a front perspective view of the spray patcher vehicle similar to FIG. 1, but showing the spray boom assembly extended to discharge emulsion and aggregate into a pothole;

FIG. 3 is an upper rear perspective of the spray patcher vehicle shown in FIGS. 1 and 2, showing a hopper and auger assembly of the aggregate system;

FIG. 4 is a fragmentary elevation view of the spray boom assembly shown in FIGS. 1 and 2, showing the dispensing head mounted on a distal boom section and supporting an emulsion spout and an aggregate spout;

FIG. 5 is a fragmentary perspective view of the spray boom assembly shown in FIGS. 1, 2, and 4;

FIG. 6 is a fragmentary perspective view of the spray boom assembly similar to FIG. 5, but taken from the opposite side;

FIG. 7 is a fragmentary perspective view of the control station, showing a user interface that includes a joystick and a display;

FIG. 8 is a schematic diagram of the aggregate system shown in FIGS. 1-3, showing the hopper, auger assembly, a pneumatic conveyance system, supply conduit, and aggregate spout, with the auger assembly including a pair of rotatable augers and a pair of hydraulic motors operably attached to the respective augers;

FIG. 9 is a schematic diagram of the emulsion system shown in FIGS. 1-3, showing an emulsion tank, tank heater, pump assembly, emulsion supply line, and emulsion spout, with the pump assembly including a hydraulic motor and a pump;

FIG. 10 is a schematic diagram of the pneumatic conveyance system shown in FIGS. 1-3, showing the blower in fluid communication with a pneumatic supply line extending to the aggregate spout;

FIG. 11 is a schematic diagram of the spray patcher vehicle shown in FIGS. 1-10, showing the control station operably associated with the emulsion system, aggregate system, and dispensing head;

FIG. 12 is a schematic diagram of the control station shown in FIG. 11, showing a processor, memory area, storage device, user interface, communication interface, and storage interface;

FIG. 13 is a diagram of a screen interface for the display shown in FIG. 7, showing the system engaged to clean out the pothole with a flow of pressurized air, with the display also depicting an adjustable flow rate indicia of aggregate and emulsion recorded by the control station for discharge by the vehicle, and further showing an adjustable ratio indicia depicting a ratio of emulsion flow to aggregate flow recorded by the control station, with the depicted indicia being associated with a setting for discharging a mixture of emulsion and aggregate;

FIG. 14 is a diagram of the screen interface for the display similar to FIG. 13, but showing the system engaged to apply a mixture of aggregate material and emulsion material inside the pothole, with the display depicting different flow rate indicia for the aggregate and emulsion and different ratio indicia compared to FIG. 13;

FIG. 15 is a diagram of the screen interface for the display similar to FIG. 14, but showing the system engaged to apply a tack coat of asphalt emulsion material along the inside surface of the pothole, with the display also having different flow rate indicia for the aggregate and emulsion, and also showing a different ratio indicia;

FIG. 16 is a diagram of the screen interface for the display shown in FIG. 7, showing indicia for displaying aggregate calibration coefficients and aggregate output rates;

FIG. 17 is a diagram of the screen interface for the display shown in FIG. 7, showing indicia for displaying an emulsion calibration coefficient and emulsion output rates;

FIG. 18 is a diagram of the screen interface for the display shown in FIG. 7, showing the relative flow rate of emulsion to aggregate;

FIG. 19 is a flow diagram of a pothole repair process;

FIG. 20 is a flow diagram of a calibration process;

FIG. 21 is a flow diagram of a parameter-setting process;

FIG. 22 is a diagram of the screen interface for the display shown in FIG. 7, showing a menu of settings for recording aggregate calibration coefficient based upon one or more aggregate calibration tests; and

FIG. 23 is a diagram of the screen interface for the display shown in FIG. 7, showing a menu of settings for recording emulsion calibration coefficient based upon one or more emulsion calibration tests.

The drawing figures do not limit the present invention to the specific embodiments disclosed and described herein. While the drawings do not necessarily provide exact dimensions or tolerances for the illustrated components or structures, the drawings, not including any purely schematic drawings, are to scale with respect to the relationships between the components of the structures illustrated therein.

### DETAILED DESCRIPTION OF THE PREFERRED EMBODIMENTS

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

### Spray Patcher Vehicle

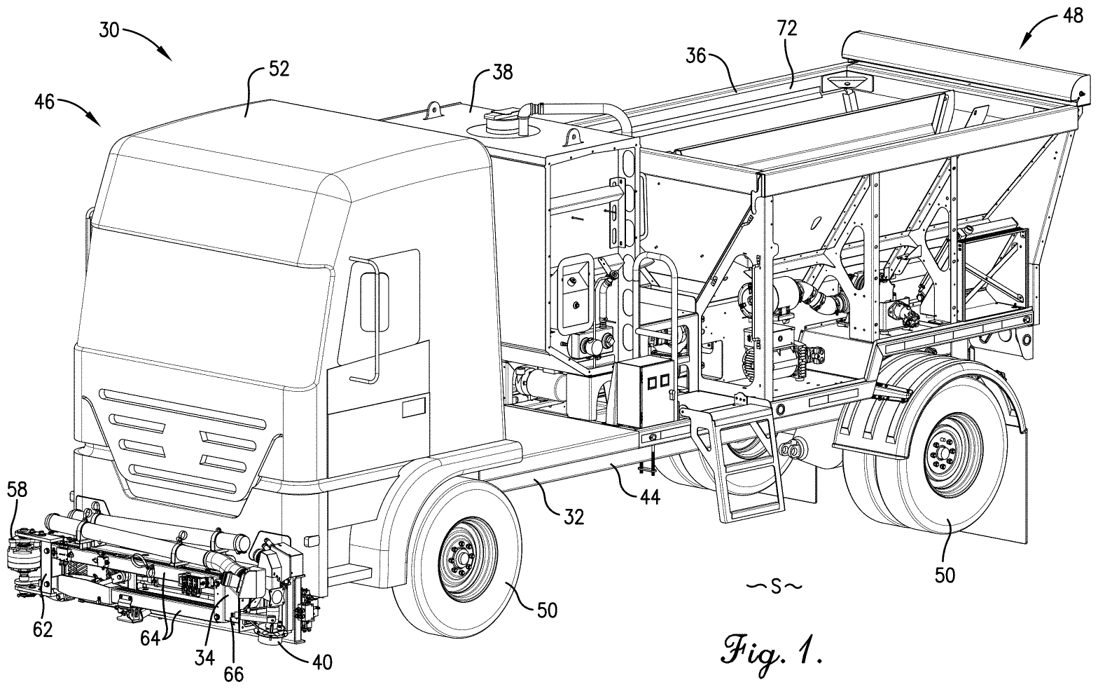

Turning to FIGS. 1-3, a spray patcher vehicle 30 is configured to repair a pothole P in a paved surface S, such as a road, path, parking lot, etc. As will be described in detail, the vehicle 30 is operable to discharge aggregate material and asphalt emulsion material into the pothole P. Furthermore, systems of the vehicle 30 facilitate completion of the repair process without any steps in the repair process being done manually by the vehicle operator or another worker, other than operating the system via the user interface.

The pothole repair process preferably includes the steps of calibrating emulsion and aggregate systems, setting operational parameters, cleaning out the pothole P, applying a tack coat of asphalt emulsion material along the inside surface of the pothole P, applying a mixture of aggregate material and emulsion material inside the pothole P to substantially fill the pothole P, and applying a covering layer of aggregate material above the mixed layer to complete the repair.

While the depicted vehicle 30 is preferably configured to dispense asphalt emulsion material and aggregate material, it is within the ambit of the present invention for the vehicle to dispense other materials for facilitating a pavement repair.

Although the illustrated vehicle 30 is preferably provided as a spray patcher vehicle, it is within the ambit of the present invention for various features to be provided as part of an alternative road surfacing vehicle. For at least certain aspects of the present invention, alternative vehicle embodiments may include other types of pothole patching vehicles or other vehicles used to repair pavement defects. Furthermore, embodiments of the vehicle may be used to repair pavement defects other than potholes, such as square cuts, rectangular cuts, alligator cracking, ruts, etc.

The spray patcher vehicle 30 broadly includes a powered chassis 32, a spray boom assembly 34, an aggregate system 36, an asphalt emulsion system 38, a material dispensing head 40, and a control station 42.

The powered chassis 32 preferably comprises a powered mobile truck for supporting other components of the vehicle 30 during vehicle advancement and operation. In the usual manner, the chassis 32 includes a chassis frame 44 that extends between forward and aft ends 46,48 to define a longitudinal vehicle axis. The chassis 32 also includes front and rear wheels 50, an internal combustion engine (not shown), and a front-mounted cab 52.

The chassis 32 is preferably configured so that the illustrated system is highly mobile and may be efficiently transported among a series of pavement repair sites. Although the illustrated vehicle 30 preferably includes a self-powered chassis, it is within the ambit of the present invention for the system to be provided on an unpowered wheeled chassis (such as a trailer). For certain aspects of the present invention, elements of the system may instead be supported on a chassis without wheels (such as a skid).

Spray boom assembly 34 facilitates the precise discharge of both emulsion material and aggregate material relative to the paved surface S. The illustrated spray boom assembly 34 shiftably supports the head 40 and preferably comprises an articulated boom with proximal and distal boom sections 54,56 that are interconnected via an articulating boom joint 58. The boom joint 58 permits relative lateral swinging movement between the boom sections 54,56. Proximal boom section 54 is attached relative to the chassis 32 at a pivot joint 60 that permits relative swinging between the proximal boom section 54 and the chassis 32.

The distal boom section 56 includes a proximal link 62 for attachment to the boom joint 58, longitudinal links 64, and a distal link 66 supporting the head 40. Preferably, distal boom section 56 provides a four-bar linkage to facilitate vertical shifting of the head 40 relative to the proximal boom section 54 and the chassis 32. However, it will be appreciated that various boom embodiments may include alternative boom structure to permit vertical shifting of the head.

The head 40 is configured to support an aggregate discharge spout 68 for the aggregate system 36 and an emulsion discharge spout 70 for the asphalt emulsion system 38. Preferably, the head 40 is pivotally supported relative to the distal link 66 and is configured to pivotally oscillate during material discharge to uniformly distribute spray patching materials.

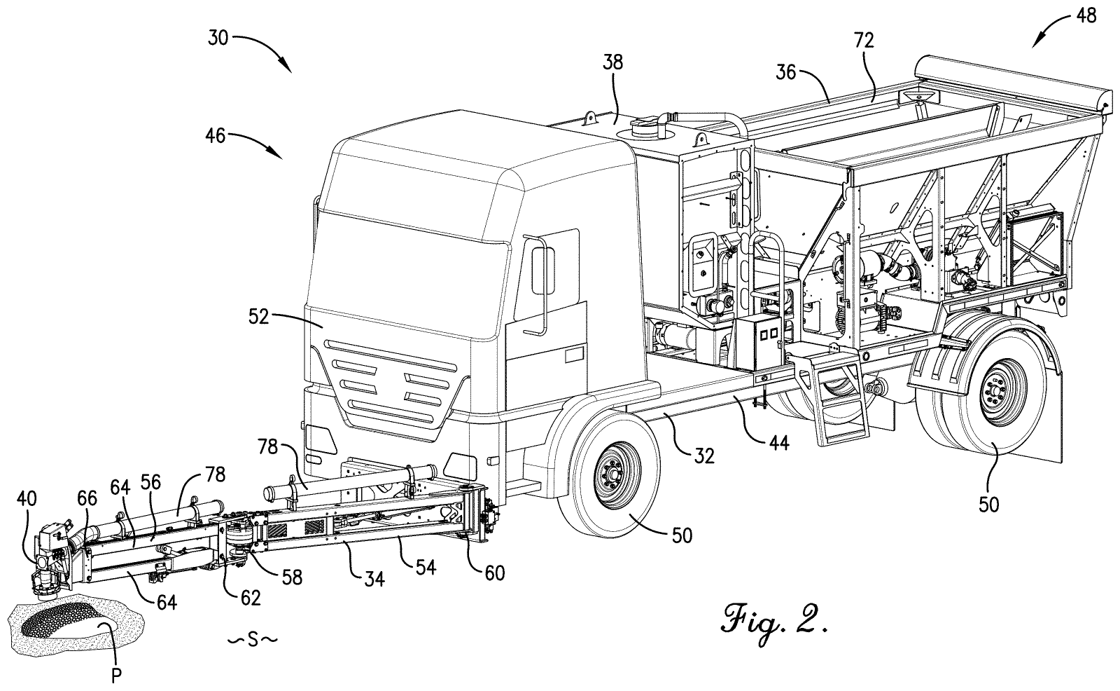

The spray boom assembly 34 is preferably shiftable between a storage condition (see FIG. 1) and an operating condition (see, e.g., FIG. 2) in which the spray boom assembly 34 is deployed to dispense spray patching material.

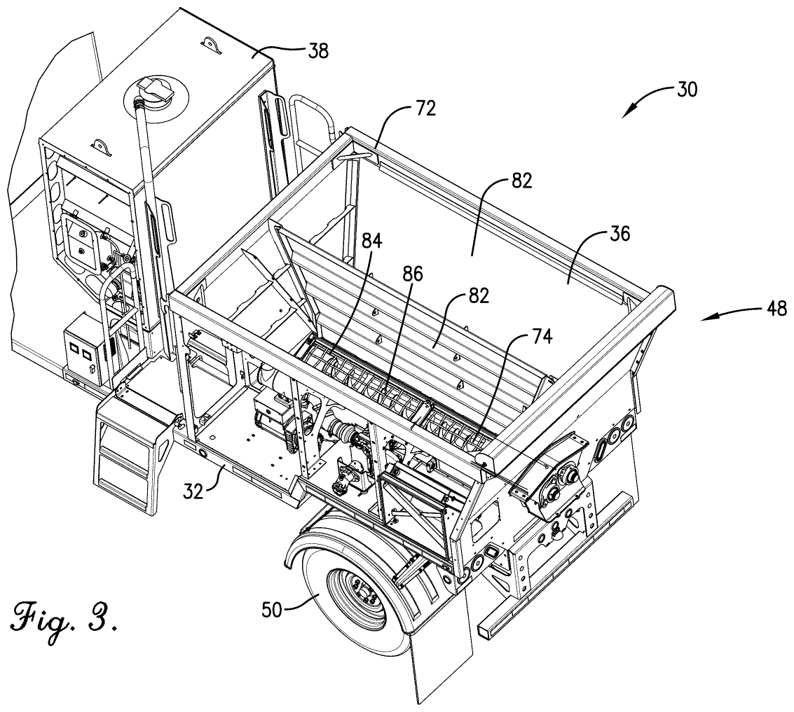

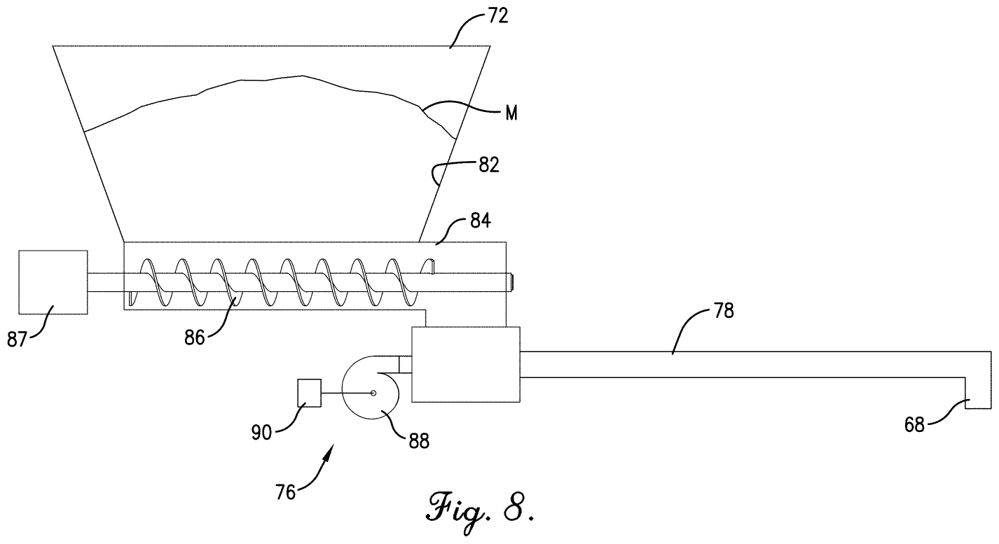

Turning to FIGS. 3 and 8, a flow of aggregate material is preferably provided via the aggregate system 36 of vehicle 30. The illustrated system 36 includes an aggregate storage hopper 72, a powered auger assembly 74, a pneumatic conveyance system 76, a supply conduit 78, and the aggregate discharge spout 68.

The hopper 72 presents a pair of interior chambers 82 (see FIGS. 3 and 8) each configured to hold a load of bulk aggregate material M. The powered auger assembly 74 includes a pair of auger conduits 84 located alongside one another, a pair of rotatable augers 86 located in the respective auger conduits 84, and hydraulic auger motors 87 associated with the respective augers 86. As is customary, the auger conduits 84 fluidly communicate with respective chambers 82 of the hopper 72 to receive aggregate material. In alternative embodiments, it will be appreciated that the vehicle may include a single auger motor that drives a single auger to draw material from a hopper. Furthermore, alternative vehicle embodiments may include a hopper with a single chamber that supplies the auger. As an auger 86 is rotated by the corresponding hydraulic auger motor 87, aggregate material is advanced by the auger 86 from the hopper 72 to the supply conduit 78.

One or both augers 86 may be driven to provide a suitable flow of aggregate material. For instance, if the same aggregate material is provided in both chambers 82 of the hopper 72, both augers 86 may be operated simultaneously to provide a relatively high flow rate of the material.

In other embodiments, chambers 82 of the hopper 72 may hold different aggregate materials. For instance, one chamber 82 may include a relatively large diameter aggregate while the other chamber 82 includes a relatively small diameter aggregate. By storing different aggregate materials in the respective chambers 82, the user may selectively dispense one of the materials by operating a corresponding auger 86. Alternatively, the user may choose to supply a blend or mixture of both aggregate materials by operating both augers 86 simultaneously.

Supply conduit 78 fluidly communicates with the auger conduits 84 to receive aggregate material from one or both augers 86 and convey the aggregate material to the discharge spout 68 provided by the dispensing head 40. In particular, the pneumatic conveyance system 76 communicates with the supply conduit 78 and provides airflow for advancing a flow of aggregate material to the dispensing head 40.

Preferably, the pneumatic conveyance system 76 includes a positive displacement blower 88 and a hydraulic blower motor 90 to drive the blower 88 (see FIG. 8). The blower 88 and blower motor 90 cooperatively provide a preferred motive air source. However, in alternative embodiments, it will be appreciated that the vehicle may include an alternative pneumatic conveyance system. For instance, various embodiments may include an alternative motive air source having an alternative motor and/or an alternative blower.

The powered auger assembly 74 provides a preferred material conveying device for supplying a precise amount of aggregate material to the dispensing head 40. However, the use of alternative mechanisms for controlling/metering the flow of aggregate material are within the ambit of the present invention. For instance, embodiments of the vehicle may include an alternative powered device (e.g., a belt conveyor) for metering the flow of aggregate. Alternative embodiments may also use a valve mechanism for metering the aggregate flow.

Emulsion system 38 of vehicle 30 is operable to provide a flow of emulsion material to the dispensing head 40. The illustrated emulsion system 38 includes an emulsion tank 92, a pump assembly 96, an emulsion supply line 98, and the emulsion discharge spout 70. The tank 92 presents an enclosed tank chamber to receive liquid emulsion material.

The pump assembly 96 includes a pump 102 and a hydraulic pump motor 104 to power the pump 102. The pump 102 fluidly communicates with the tank chamber and the emulsion supply line 98 to convey emulsion material to the discharge spout 70 provided by the dispensing head 40. That is, the pump 102 advances a flow of emulsion material to the dispensing head 40 via the emulsion supply line 98.

The powered pump 102 assembly provides a preferred material conveying device for supplying a precise amount of emulsion material to the dispensing head 40. However, the use of alternative mechanisms for controlling/metering the flow of emulsion material are within the ambit of the present invention. For instance, embodiments of the vehicle may include an alternative powered device for metering the flow of emulsion. Alternative embodiments may also use a valve mechanism for metering the emulsion flow.

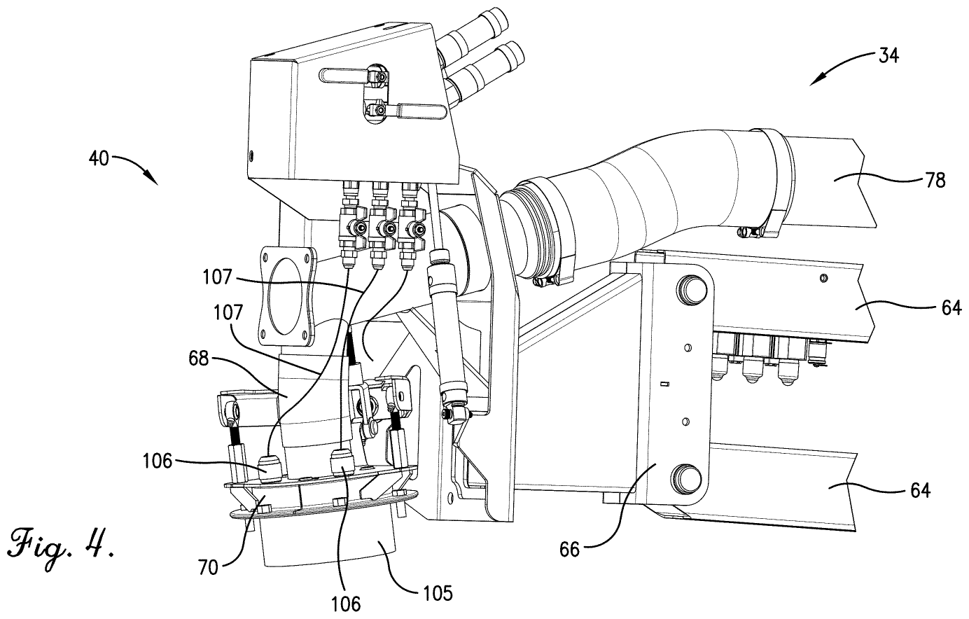

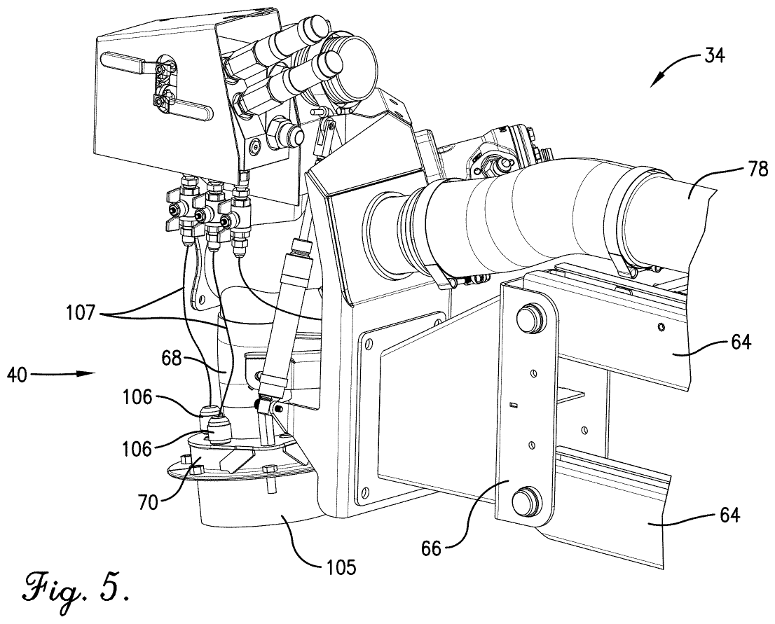

The emulsion discharge spout 70 preferably includes a housing 105, multiple spray nozzles (not shown) for cooperatively dispensing a flow of emulsion material, and hose fittings 106 that fluidly communicate with the nozzles and emulsion lines 107 (see FIGS. 4 and 5). Embodiments of the emulsion discharge spout 70 may be variously configured without departing from the scope of the present invention.

Control station 42 is operable so that the vehicle 30 is configured to discharge a calibrated flow of a spray patching material. In the illustrated embodiment, the control station 42 is located within the cab 52 and is configured to operate components of the vehicle 30 associated with each step of the pavement repair process.

As noted above, the pothole repair process preferably includes the steps of calibrating the emulsion and aggregate systems, setting operational parameters, cleaning out the pothole P, applying a tack coat of emulsion material along the inside surface of the pothole P, applying a mixed layer of aggregate material and emulsion material inside the pothole P to substantially fill the pothole P, and applying a covering layer of aggregate material above the mixed layer to complete the repair. The control station 42 is also configured to perform other operational steps related to dispensing material, dispensing compressed air, equipment maintenance (such as clean-out of emulsion material), etc.

Control station 42 preferably includes a processor 110, memory 112, storage device 114, and a user interface 116. The depicted user interface 116 includes a joystick 118 and a touch-sensitive display 120. The user interface 116 also preferably includes a control knob 121 configured for adjusting the rate of spray patching material (that is, aggregate or emulsion) discharged by the system.

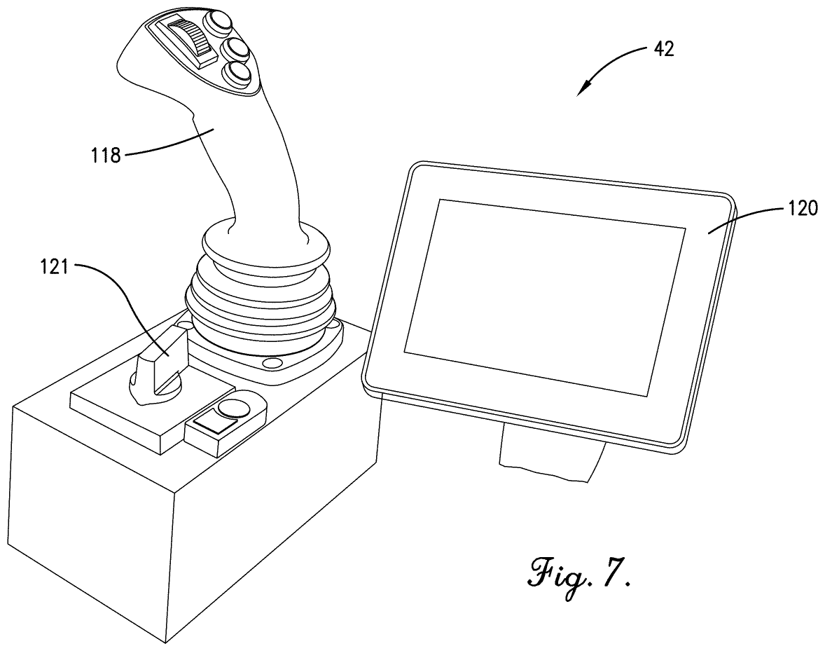

FIG. 7 is an example configuration of the control station 42. Again, in the depicted embodiment, the control station 42 includes the processor 110 for executing instructions. The instructions may be stored in a memory area 112, for example. The processor 110 includes one or more processing units (e.g., in a multi-core configuration) for executing the instructions. The instructions may be executed within a variety of different operating systems on the control station 42, such as UNIX, LINUX, Microsoft Windows®, etc. More specifically, the instructions may cause various data manipulations on data stored in the storage device 114. It should also be appreciated that upon initiation of a computer-based method, various instructions may be executed during initialization. Some operations may be required to perform one or more processes described herein, while other operations may be more general and/or specific to a programming language (e.g., C, C#, C++, Java, Python, or other suitable programming languages, etc.).

The processor 110 is operably coupled to the auger assembly 74 of the aggregate system 36 and the pump assembly 96 of the emulsion system 38. In particular, the processor 110 is operably coupled to the motors 87 and 104 of the respective systems to control operation of the auger assembly 74 and the pump assembly 96.

Processor 110 may be operatively coupled to a communication interface 122 such that the control station 42 can communicate with a remote device (not shown).

Processor 110 is also operatively coupled to the storage device 114. The storage device 114 is any computer-operated hardware suitable for storing and/or retrieving data. In some embodiments, the storage device 114 is integrated in the control station 42. In other embodiments, the storage device 114 is external to the control station 42, such as a third party data repository or database. For example, the control station 42 may include one or more hard disk drives as the storage device 114. In other embodiments, the storage device 114 is external to the control station 42 and may be accessed by a plurality of control stations 42. For example, the storage device 114 may include multiple storage units such as hard disks or solid-state disks in a redundant array of inexpensive disks (RAID) configuration. The storage device 114 may include a storage area network (SAN) and/or a network attached storage (NAS) system.

In some embodiments, the processor 110 is operatively coupled to the storage device 114 via a storage interface 124. The storage interface 124 is any component capable of providing the processor 110 with access to the storage device 114. The storage interface 124 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 110 with access to the storage device 114.

The memory area 112 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

In some embodiments, it is contemplated that the control station 42 is implemented as a software application. In such embodiments, the hardware described above, such as the processor 110, the memory area 112, the communication interface 122, and/or the storage interface 124 may be shared with the hardware components of a cloud based system (not shown).

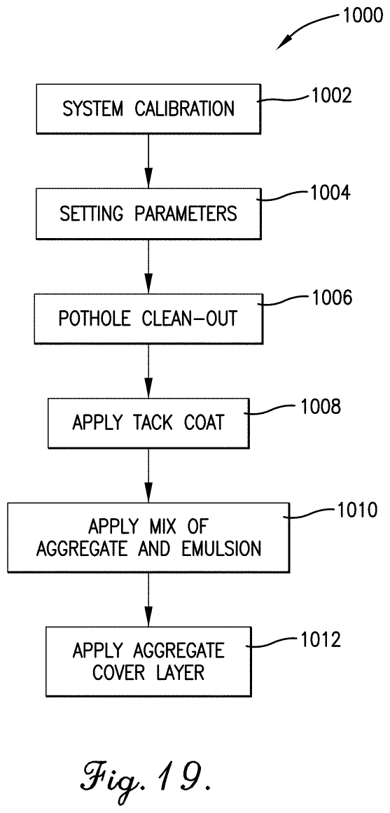

FIG. 19 is a flowchart illustrating an exemplary computer-implemented method 1000 for repairing a pothole in a paved surface, in accordance with one embodiment of the present invention. The operations described herein may be performed in the order shown in FIG. 19 or may be performed in a different order. Furthermore, some operations may be performed concurrently as opposed to sequentially. In addition, some operations may be optional.

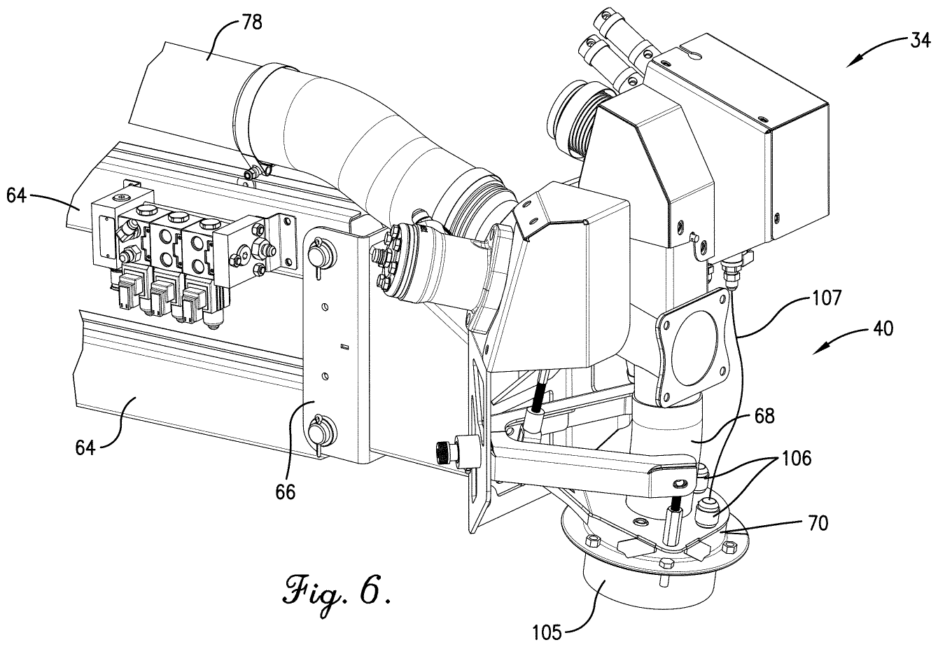

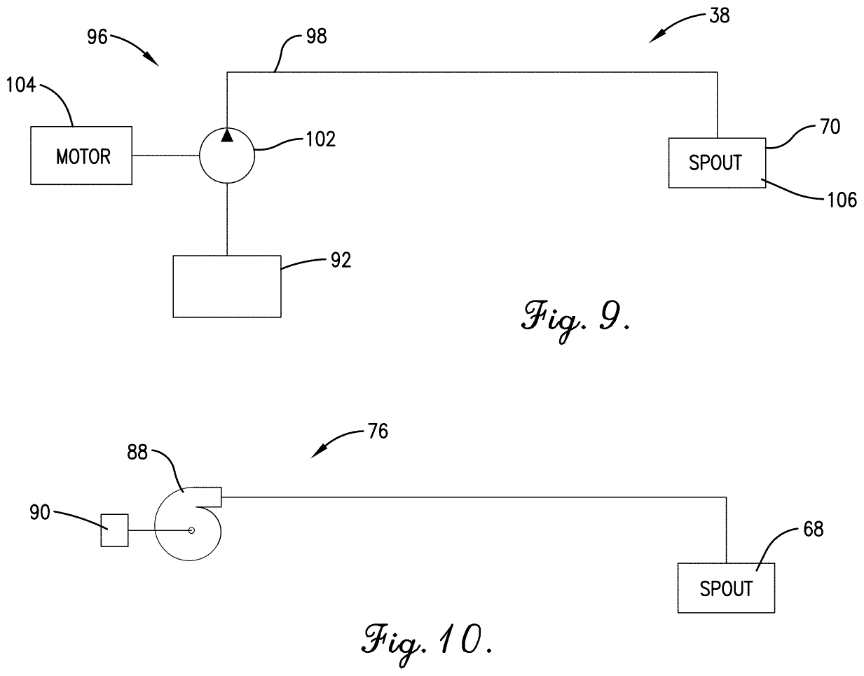

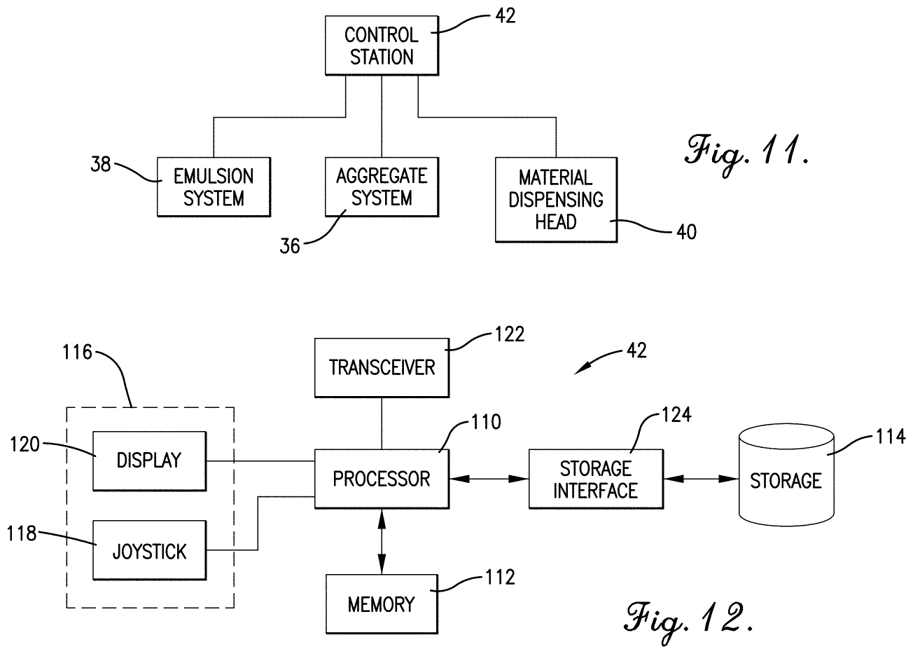

The computer-implemented method 1000 is described below, for ease of reference, as being executed by exemplary devices and components introduced with the embodiments illustrated in FIGS. 1-9. In one embodiment, the method 1000 may be implemented by the vehicle 30, particularly using the depicted control station. While operations within the method 1000 are described below regarding the vehicle 30, the method 1000 may be implemented on other such computing devices and/or systems through the utilization of processors, transceivers, hardware, software, firmware, or combinations thereof. However, a person having ordinary skill will appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

### Vehicle Operation

In operation, the vehicle 30 is configured to be operated by a user located in the cab 52 to repair the pothole P. In preferred embodiments, the user is the sole person operating the vehicle 30 during the repair process and is also the sole person conducting the repair. Thus, the illustrated vehicle 30 permits the user to repair the pothole P without assistance from any other person at the repair site.

Again, the pothole repair process preferably includes the steps of calibrating emulsion and aggregate systems (operation 1002), setting operational parameters (operation 1004), cleaning out the pothole P (operation 1006), applying a tack coat of asphalt emulsion material along the inside surface of the pothole P (operation 1008), applying a mixture of aggregate material and emulsion material inside the pothole P to substantially fill the pothole P (operation 1010), and applying a covering layer of aggregate material above the mixed layer to complete the repair (operation 1012).

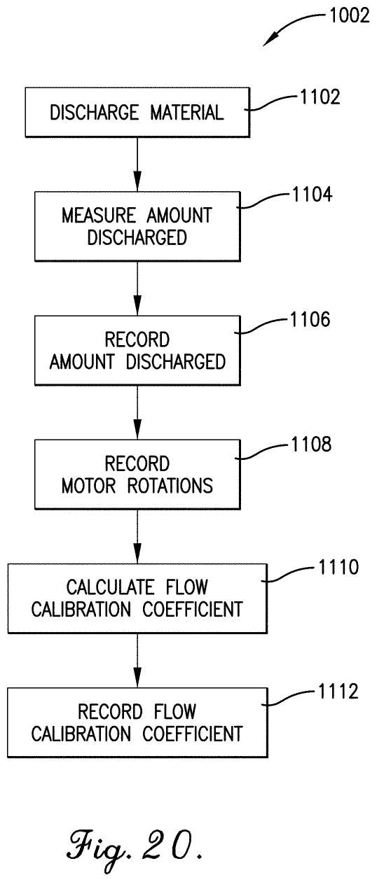

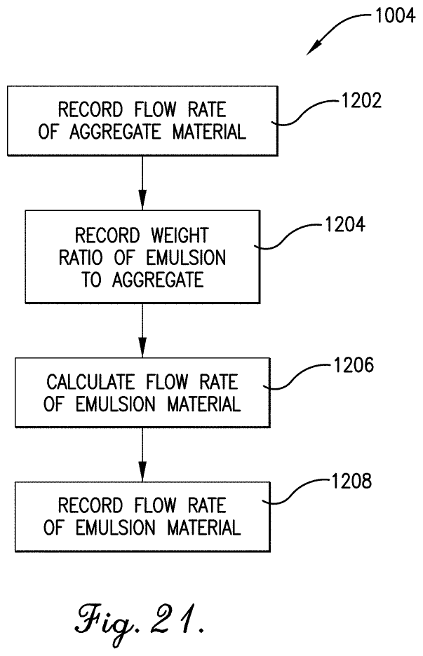

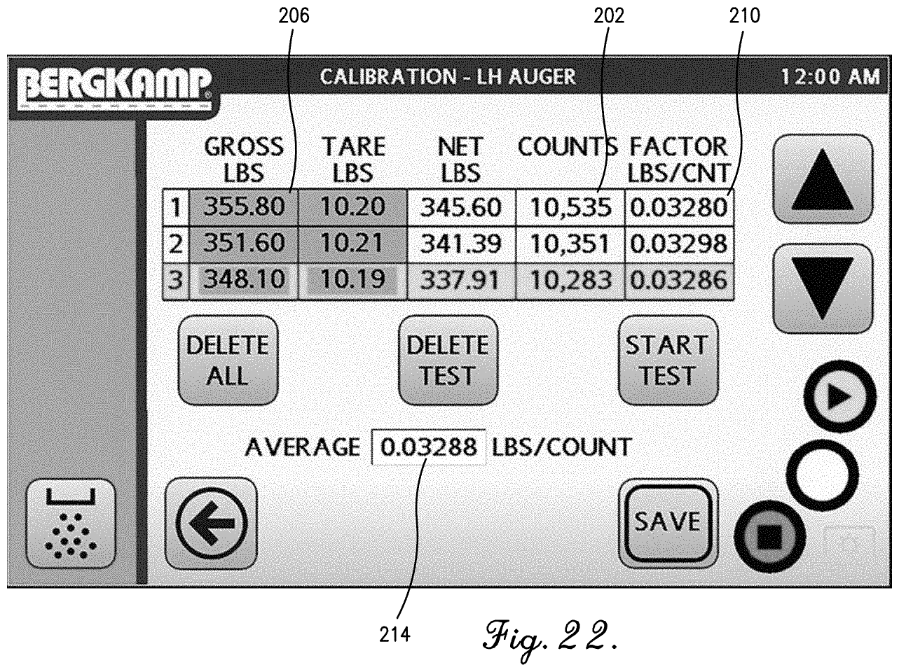

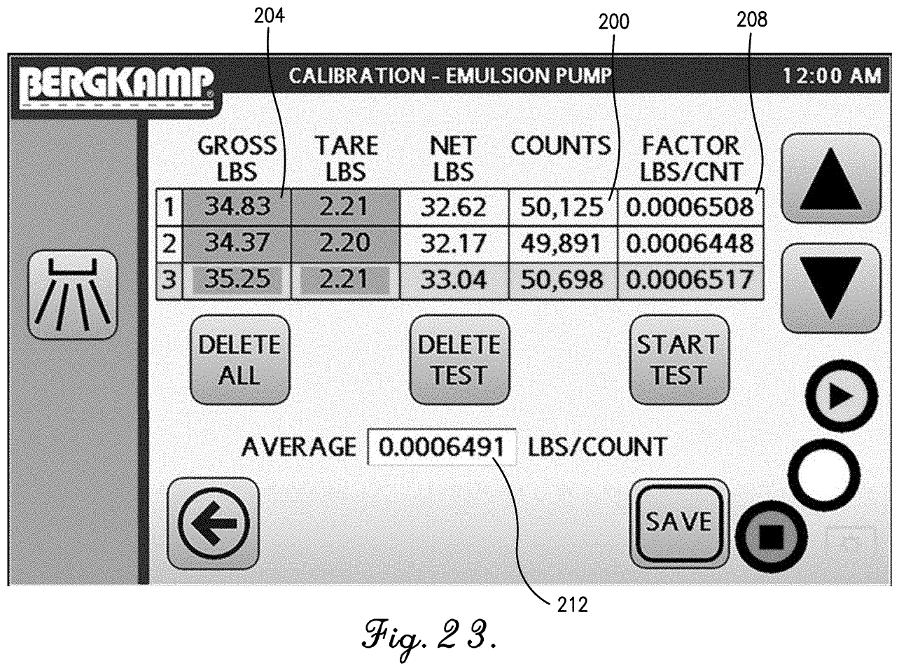

At operation 1002, the control station 42 facilitates calibration of the aggregate and emulsion systems 36 and 38 (see FIGS. 19 and 20). In the illustrated embodiment, the control station 42 enables a user to conduct a calibration test by discharging a spray patching material (in the present embodiment, discharging either emulsion or aggregate material) from the head 40 for a period of time at step 1102. The amount of material discharged during that test may then be measured at step 1104 and recorded at step 1106. For instance, the processor 110 may operate the motor 104 of the emulsion system 38 to discharge an amount of emulsion material for a corresponding test. The number of “counts” (identified by indicia 200), associated with partial or full shaft rotations, for a particular calibration test may be recorded and displayed in a calibration screen presented by the display (see FIG. 23). Similarly, the processor 110 may operate one or both auger motors 87 of the aggregate system 36 to discharge an amount of aggregate material. The number of “counts” (identified by indicia 202), associated with partial or full shaft rotations, for a particular calibration test may be recorded and displayed in a calibration screen presented by the display (see FIG. 22). It will be understood that each auger motor 87 of the auger assembly 74 may be operated to calibrate a corresponding auger 86. Preferably, only one auger motor 87 of the auger assembly 74 is operated at a particular time for calibration purposes.

Whether the discharged material comprises emulsion or aggregate, the user may collect material discharged from the head 40 in a container (not shown), measure the amount of discharged material (e.g., by weighing the discharged material) at step 1104, and manually enter the weighed amount of material into the control station 42 at step 1106, with this value being recorded by the processor 110. The measured weight of discharged material (identified by indicia 204 and 206), associated with partial or full shaft rotations, for a particular calibration test may be recorded and displayed in a calibration screen presented by the display (see FIGS. 22 and 23). It will also be understood that the control station 42 may be operably coupled to a sensor (e.g., a force sensor, optical sensor, etc.) for sensing the amount of discharged material at step 1104, so that the control station 42 may record the sensed amount of material at step 1106. By determining the amount of collected material in this manner, an average flow rate of material is measured by this process.

The control station 42 enables the user to record the number of partial or full motor rotations sensed by a sensor and associated with the discharged spray patching material at step 1108. As used herein, the terms “motor rotation” and “sensed motor rotation” preferably include sensing of a partial shaft revolution, where the system senses a discrete amount of rotation less than a full revolution of three hundred sixty degrees (360°). However, in other embodiments, the term “motor rotation” may include sensing of a full shaft revolution, where the system senses a full revolution of three hundred sixty degrees (360°). In preferred embodiments, the control station 42 receives pulses or “counts” from a shaft speed sensor, and each pulse or “count” corresponds to a sensed motor rotation, as discussed below.

Preferably, the auger assembly 74 and the pump assembly 96 each include a sensor (not shown) to sense shaft rotation of the corresponding motor and the sensors are operably coupled to the processor 110. For instance, when driving the pump to discharge emulsion, the control station 42 may determine the number of motor rotations sensed while discharging an amount of emulsion material. The sensed number of motor rotations may be recorded by the processor 110 at step 1108.

The control station 42 preferably receives pulses or “counts” from the motor speed sensor. Each of such pulses may correspond to a discrete amount of shaft rotation less than a full revolution of three hundred sixty degrees (360°). For instance, in preferred embodiments, a sensor may provide one hundred eighty (180) counts per full shaft revolution. Based upon this sensing resolution, the system may sense 1/180th of a revolution (which equates to a pulse for every two degrees of rotation).

The number of sensed motor rotations (whether each sensed “rotation” is a partial or full revolution) provides a preferred device operational value associated with the amount of emulsion discharged. However, it is within the scope of the present invention to use another device operational value. For instance, the vehicle may include a sensor to measure the number of sensed shaft rotations of a rotating pump element (such as a pump shaft).

Similarly, when driving one of the augers 86 to discharge aggregate, the control station 42 may determine the number of sensed motor rotations that are sensed while discharging an amount of aggregate material. Again, the sensed number of motor rotations may be recorded by the processor 110 at step 1108.

The number of sensed motor rotations (whether each sensed “rotation” is a partial or full revolution) provides a preferred device operational value associated with the amount of aggregate discharged. However, it is within the scope of the present invention to use another device operational value. For instance, the vehicle may include a sensor to measure the number of sensed shaft rotations of a rotating auger element (such as an auger shaft).

With the amount of discharged material and the corresponding number of sensed motor rotations being recorded, the control station 42 may calculate the flow calibration coefficient for a particular calibration test at step 1110 and record the flow calibration coefficient at step 1112. The flow calibration coefficient may be calculated by dividing the amount of discharged material by the corresponding number of motor rotations, resulting in a calculated amount of spray patching material per motor revolution. For instance, an emulsion flow calibration coefficient may be calculated by dividing an amount of discharged emulsion material by the number of sensed motor rotations of the pump assembly. The processor 110 may record the calculated emulsion flow calibration coefficient.

Similarly, an aggregate flow calibration coefficient may be calculated for each auger 86 and respective auger motor 87 by dividing an amount of discharged aggregate material by the number of sensed motor rotations of the auger assembly 74. The processor 110 may record the calculated aggregate flow calibration coefficient.

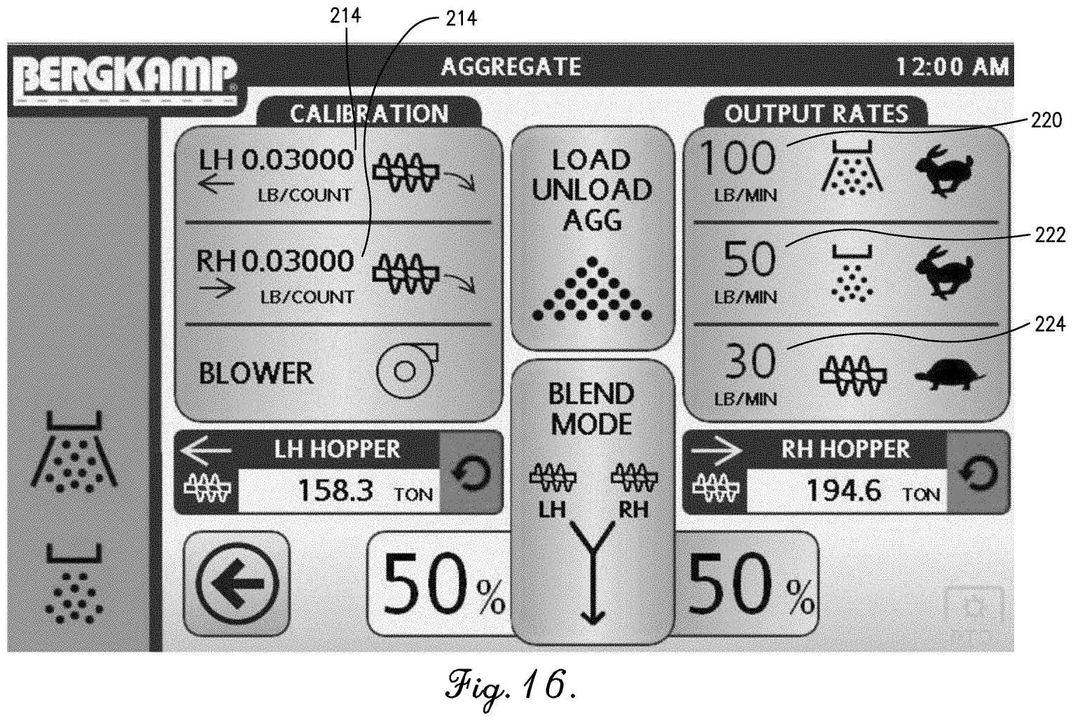

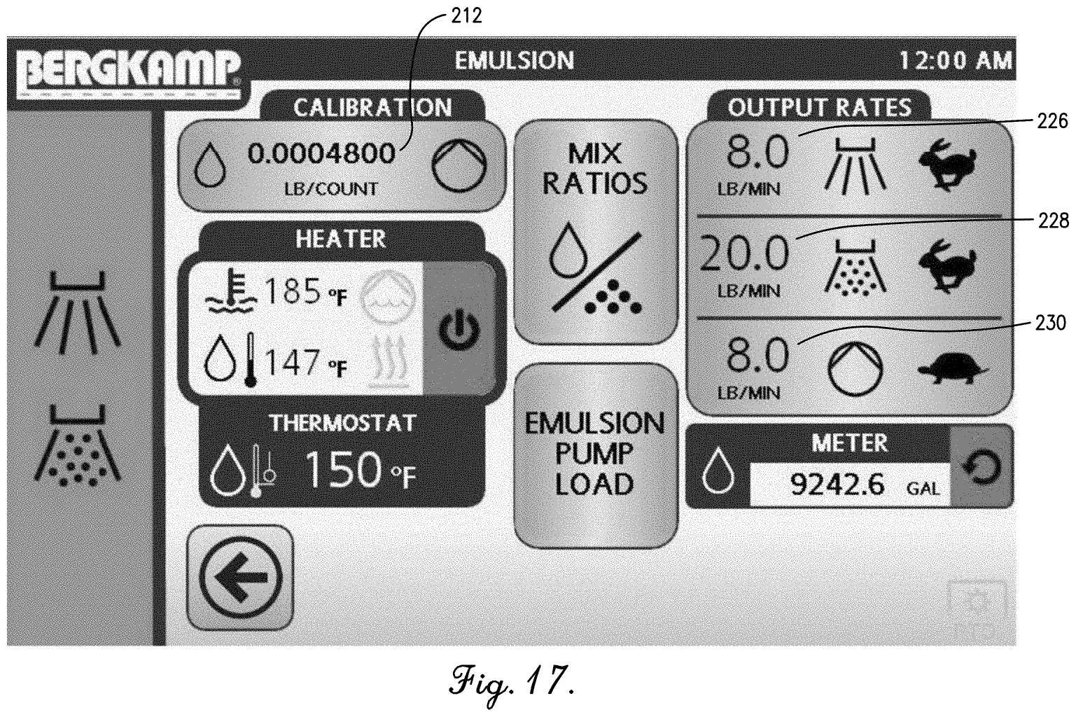

Examples illustrating settings for flow calibration coefficient of aggregate and emulsion, entered into the display 120, are depicted in FIGS. 16 and 17. As will be discussed, the processor 110 preferably uses the flow calibration coefficients to calculate a motor rotational speed for providing a calibrated flow of spray patching material.

As depicted in FIGS. 22 and 23, it will be understood that the system is configured to conduct multiple calibration tests and to calculate and display a flow coefficient (see indicia 208 and 210) for each of those tests. The system may also calculate and display an average flow coefficient (see indicia 212 and 214) by averaging the flow coefficient values from the individual tests (see FIGS. 22 and 23). The average flow coefficient values 212 and 214 are also displayed for the user in the aggregate settings menu (see FIG. 16) and the emulsion settings menu (see FIG. 17).

For at least certain aspects of the present invention, embodiments of the repair process may include one or more alternative calibration steps associated with operation 1002. Furthermore, it is within the scope of certain aspects of the present invention for the repair process to be devoid of one or more steps of operation 1002 or to be devoid entirely of operation 1002.

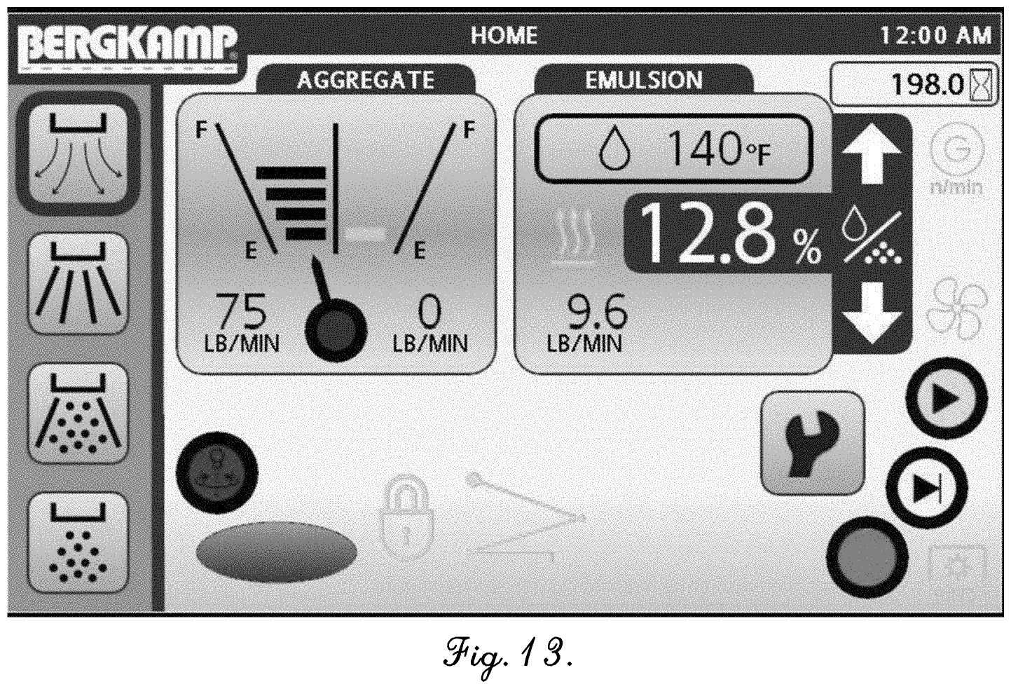

At operation 1004, the control station 42 facilitates the setting of various operational parameters for the aggregate and emulsion systems 36 and 38 (see FIGS. 19 and 21). Preferably, the control station 42 enables the user to record a flow rate of aggregate material and to record a flow rate of emulsion material. In the depicted embodiment, the user manually enters a desired flow rate of aggregate material and a desired weight ratio of emulsion to aggregate, and these values are recorded by the processor at steps 1202 and 1204, respectively. The processor 110 preferably calculates the flow rate of emulsion material by multiplying the recorded flow rate of aggregate material by the recorded weight ratio at step 1206. This calculated flow rate of emulsion material is also recorded by the processor 110 at step 1208. Examples illustrating settings for aggregate flow rate, emulsion flow rate, and ratio of emulsion to aggregate, entered into the display 120, are depicted in FIGS. 13-15 and 18. However, it will also be understood that the flow rate of aggregate, flow rate of emulsion, and/or the recorded weight ratio may be modified at other times during the patching process. In at least some steps of the disclosed process, the user may adjust the knob 121 to modify the flow rates of emulsion and/or aggregate discharged by the system. Most preferably, the system facilitates adjustment of emulsion flow rate and/or aggregate flow rate while maintaining a desired weight ratio of discharged emulsion and aggregate.

Turning to FIG. 16, the display 120 may permit the user to set values of maximum aggregate flow rate associated with applying a mix of aggregate and emulsion during operation 1010 (see indicia 220), maximum aggregate flow rate associated with applying an aggregate cover layer during operation 1012 (see indicia 222), and minimum aggregate flow rate associated with operations 1010 and 1012 (see indicia 224).

Similarly in FIG. 17, the display 120 may permit the user to set values of maximum emulsion flow rate associated with applying a tack coat of emulsion during operation 1008 (see indicia 226), maximum emulsion flow rate associated with applying a mix of aggregate and emulsion during operation 1010 (see indicia 228), and minimum emulsion flow rate associated with operations 1008 and 1010 (see indicia 230).

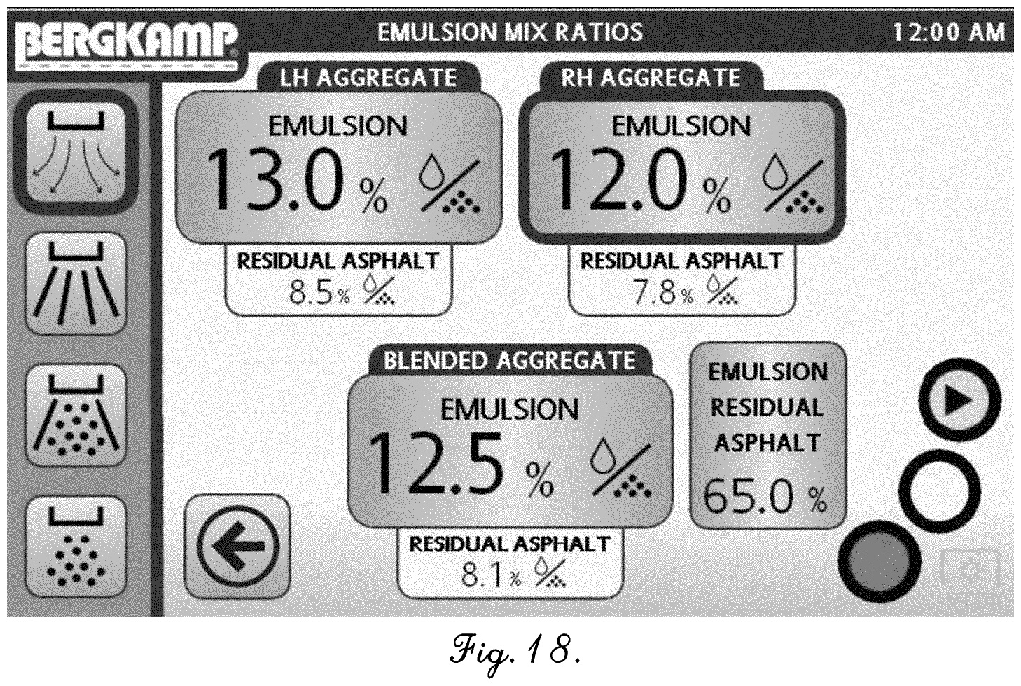

FIG. 18 illustrates a screen provided by the display 120 for setting the relative flow rate of aggregate to emulsion.

It is also within the ambit of the present invention for the flow rates of aggregate and emulsion to be alternatively set and recorded by the control station. For instance, the control station may permit the user to manually enter a desired flow rate of emulsion material and a desired weight ratio of aggregate to emulsion.

Based upon the recorded values of aggregate flow rate associated with each auger and the recorded value of emulsion flow rate, the processor 110 preferably uses the flow calibration coefficients to calculate a corresponding motor rotational speed for providing a calibrated flow of emulsion material and a calibrated flow of aggregate material.

For instance, a rotational speed of the motor 104 for the emulsion system 38 may be calculated by dividing the recorded emulsion flow rate by the emulsion flow calibration coefficient, and the processor 110 may record the calculated motor rotational speed for the pump assembly 96. Similarly, a rotational speed of the auger motor 87 for the aggregate system 36 may be calculated by dividing the recorded aggregate flow rate by the aggregate flow calibration coefficient, and the processor 110 may record the calculated motor rotational speed for the auger assembly 74.

It is within the scope of at least certain aspects of the present invention for the control station to determine an alternative device speed for operating the pump assembly or otherwise supplying the emulsion flow. It is also within the scope of at least certain aspects of the present invention for the control station to determine an alternative device speed for operating the auger assembly or otherwise supplying the aggregate flow.

Again, an average flow rate of material supplied by the emulsion system 38 or the aggregate system 36 may be measured via the calibration process described above. The process of determining a flow calibration coefficient and having the processor 110 record an updated flow calibration coefficient enables the control station 42 to adjust operation of the emulsion system 38 and/or the aggregate system 36 to reduce any difference between a desired flow rate of material and a measured flow rate of material. By updating the flow calibration coefficient, the control station 42 is configured to adjust operation of the emulsion system 38 and/or the aggregate system 36 (e.g., by increasing a motor rotational speed associated with one system and/or decreasing a motor rotational speed associated with the other system).

In various embodiments, the control system may be configured to compare a desired flow rate of material and a measured flow rate of material for determining a suitable operational adjustment to the emulsion system and/or the aggregate system.

For at least certain aspects of the present invention, embodiments of the repair process may include one or more alternative parameter-setting steps associated with operation 1004. Furthermore, it is within the scope of certain aspects of the present invention for the repair process to be devoid of one or more steps of operation 1004 or to be devoid entirely of operation 1004.

At operation 1006, the control station activates the pneumatic conveyance system 76 to supply airflow through the supply conduit 78 and out of the aggregate spout 68 for cleaning out the pothole P. In particular, the processor 110 engages the blower motor 90 of the pneumatic conveyance system 76 at a desired rotational speed to drive the blower 88. It will be appreciated that the blower rotational speed may be variable during the patching process. The screen interface provided by the display 120 and associated with operation 1006 of the process is shown in FIG. 13.

For at least certain aspects of the present invention, embodiments of the repair process may include one or more alternative pothole clean-out steps associated with operation 1006. Furthermore, it is within the scope of certain aspects of the present invention for the repair process to be devoid of one or more steps of operation 1006 or to be devoid entirely of operation 1006.

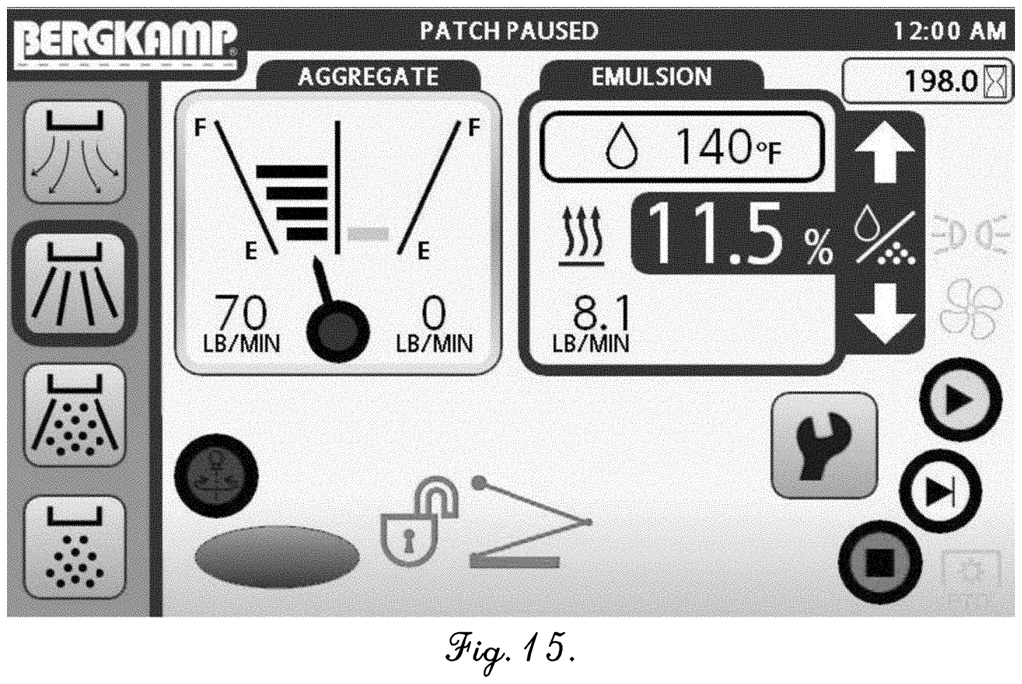

At operation 1008, the control station 42 engages the emulsion system 38 to discharge a flow of emulsion material for applying a tack coat of emulsion to the inside surface of the pothole P. The processor 110 engages the motor 104 of the emulsion system 38 at a desired rotational speed to drive the pump 102. It will be appreciated that the pump rotational speed may be variable. For instance, the desired pump rotational speed may be set by the user prior to operation and/or at various times during the patching process (e.g., associated with a change in the corresponding flow rate of emulsion, where the system maintains a desired weight ratio of emulsion and aggregate). The screen interface provided by the display 120 and associated with operation 1008 of the process is shown in FIG. 15.

For at least certain aspects of the present invention, embodiments of the repair process may include one or more alternative steps associated with operation 1008. Furthermore, it is within the scope of certain aspects of the present invention for the repair process to be devoid of one or more steps of operation 1008 or to be devoid entirely of operation 1008.

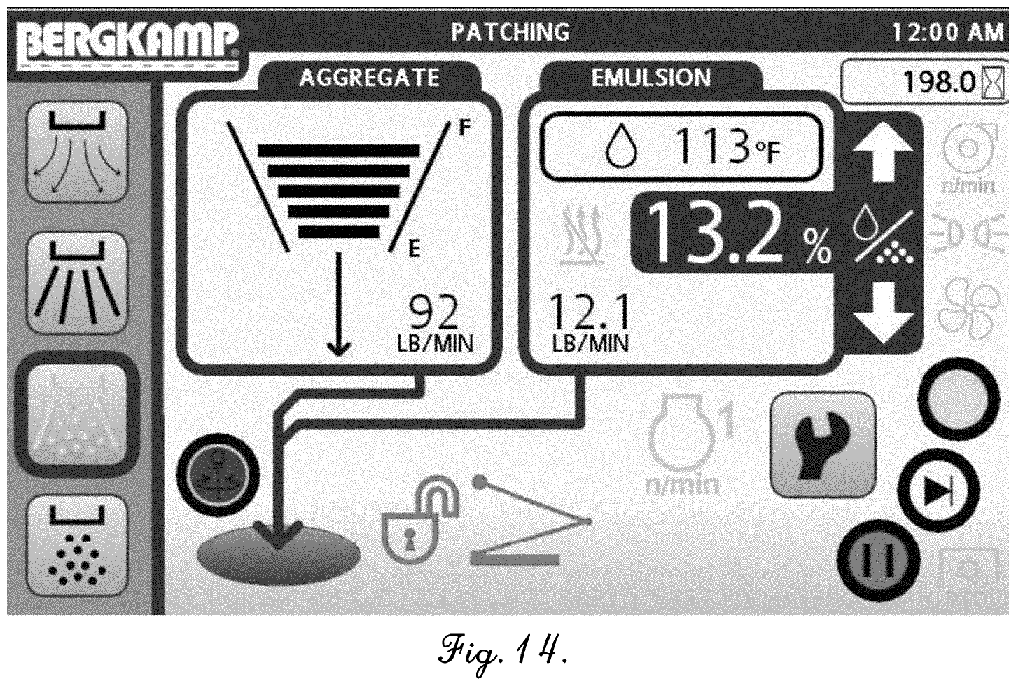

At operation 1010, the control station 42 engages the emulsion system 38 to discharge a flow of emulsion material into the pothole P and also engages the aggregate system 36 to discharge a flow of aggregate material into the pothole P. The processor 110 engages the motor 104 of the emulsion system 38 at a desired rotational speed to drive the pump 102. The processor 110 also engages one or both auger motors 87 of the auger assembly 74 at a desired rotational speed to drive one or both of the augers 86. It will be appreciated that the rotational speed of each auger motor may be variable. For example, the desired auger rotational speed may be set by the user prior to operation and/or at various times during the patching process (e.g., associated with a change in the corresponding flow rate of aggregate, where the system maintains a desired weight ratio of emulsion and aggregate). The screen interface provided by the display 120 and associated with operation 1010 of the process is shown in FIG. 14.

As described above, one or both augers 86 may be driven to provide a suitable flow of aggregate material. For instance, where chambers 82 of the hopper 72 include a common aggregate material, both augers 86 may be operated simultaneously to provide a relatively high flow rate of the material. Again, as noted above, alternative vehicle embodiments may include a single auger and a hopper with a single chamber that supplies the auger.

In other embodiments, chambers 82 of the hopper 72 may include different aggregate materials. For instance, one chamber 82 may include a relatively large diameter aggregate while the other chamber 82 includes a relatively small diameter aggregate. By storing different aggregate materials in the respective chambers 82, the user may selectively dispense one of the materials by operating a corresponding auger 86. Alternatively, the user may choose to supply a blend or mixture of both materials by operating both augers 86 simultaneously. As depicted in FIGS. 13-16, relative amounts of aggregate may be selected by the user for providing a flow of blended aggregate.

For at least certain aspects of the present invention, embodiments of the repair process may include one or more alternative steps associated with operation 1010. Furthermore, it is within the scope of certain aspects of the present invention for the repair process to be devoid of one or more steps of operation 1010 or to be devoid entirely of operation 1010.

At operation 1012, the control station 42 engages the aggregate system 36 to discharge a flow of aggregate material for applying an uppermost layer of aggregate to complete repair of the pothole P. The processor 110 engages one or both of the auger motors 87 of the auger assembly 74 at a desired rotational speed to drive one or both of the augers 86. Again, similar to operation 1010, it will be appreciated that the rotational speed of each auger motor may be variable. The desired auger speed may be set by the user prior to operation and/or at various times during the patching process (e.g., to change the corresponding flow rate of aggregate). Again, one or both augers may be driven to provide a suitable flow of aggregate material.

For at least certain aspects of the present invention, embodiments of the repair process may include one or more alternative steps associated with operation 1012. Furthermore, it is within the scope of certain aspects of the present invention for the repair process to be devoid of one or more steps of operation 1012 or to be devoid entirely of operation 1012.

Although the present invention has been described in detail, it should be understood that various changes, substitutions and alterations can be made thereto without departing from the spirit and scope of the invention as defined by the appended claims.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

1. A pothole spray patcher vehicle configured to discharge a calibrated flow of a spray patching material, said pothole spray patcher vehicle comprising:
a material conveying device including a motor and configured to supply spray patching material to a discharge spout; and
a processor being operably coupled to the material conveying device and configured to—
determine a flow calibration coefficient by operating the conveying device to discharge an amount of spray patching material from the spout, recording the amount of spray patching material discharged, recording a device operational value associated with the amount of spray patching material discharged, and calculating the flow calibration coefficient based upon the recorded amount of spray patching material and the recorded device operational value;
record a selected flow rate of spray patching material set by the user;
calculate a device speed based upon the recorded selected flow rate and the calculated flow calibration coefficient; and
operate the conveying device at the calculated device speed.

2. The pothole spray patcher as claimed in claim 1,
said spray patching material including an aggregate material and/or an emulsion material.

3. The pothole spray patcher as claimed in claim 1,
said device operational value comprising the number of sensed motor rotations associated with the amount of spray patching material discharged.

4. The pothole spray patcher as claimed in claim 3, said flow calibration coefficient being calculated by dividing the amount of spray patching material discharged by the associated number of sensed motor rotations.

5. The pothole spray patcher as claimed in claim 1,
said device speed comprising the motor rotational speed.

6. The pothole spray patcher as claimed in claim 1,
said material conveying device including a pump operably powered by the motor, with the spray patching material comprising an emulsion material configured to be conveyed by the pump.

7. The pothole spray patcher as claimed in claim 6,
said step of determining the flow calibration coefficient including the step of measuring the amount of emulsion material discharged.

8. The pothole spray patcher as claimed in claim 1,
said material conveying device comprising an auger operably powered by the motor, with the spray patching material comprising an aggregate material configured to be conveyed by the auger.

9. The pothole spray patcher as claimed in claim 8,
said step of determining the flow calibration coefficient including the step of measuring the amount of aggregate material discharged.

10. The pothole spray patcher as claimed in claim 1,
another material conveying device including another motor and configured to supply another spray patching material to another discharge spout.

11. The pothole spray patcher as claimed in claim 10,
said material conveying device including a pump operably powered by the motor, with the spray patching material comprising an emulsion material configured to be conveyed by the pump,
said another material conveying device including an auger operably powered by the another motor, with the another spray patching material comprising an aggregate material configured to be conveyed by the auger.

12. The pothole spray patcher as claimed in claim 10, said processor operably coupled to the another material conveying device and configured to—
determine another flow calibration coefficient by operating the another conveying device to discharge an amount of said another spray patching material from the another discharge spout, recording the amount of said another spray patching material discharged, recording another device operational value associated with the amount of said another spray patching material discharged, and calculating the another flow calibration coefficient based upon the recorded amount of said another spray patching material and the recorded another device operational value;
calculate another device speed based upon a selected flow rate of the another spray patching material and the calculated flow calibration coefficient; and
operate the another conveying device at the calculated another device speed.

13. The pothole spray patcher as claimed in claim 12, wherein the processor is further configured to—
record a selected ratio of the spray patching material flow and the another spray patching material flow set by the user; and
calculate a flow rate of the another spray patching material based upon the recorded spray patching material flow rate and the recorded ratio.

14. The pothole spray patcher as claimed in claim 13, wherein the processor is further configured to—
operate the second material conveying device to provide the flow of second spray patching material based upon the calculated flow rate;
determine a measured flow rate of the provided flow of second spray patching material; and
adjust operation of the second material conveying device to reduce any difference between the calculated flow rate and the measured flow rate.

15. A pothole spray patcher vehicle configured to set a desired mixture of dispensed spray patching materials, said pothole spray patcher vehicle comprising:
a first material conveying device operable to supply a flow of first spray patching material;
a second material conveying device operable to supply a flow of second spray patching material; and
a processor being operably coupled to the material conveying devices and configured to—record a selected flow rate of the first spray patching material set by the user;
record a selected ratio of the first spray patching material flow and the second spray patching material flow set by the user; and
calculate a flow rate of the second spray patching material based upon the recorded first spray patching material flow rate and the recorded ratio.

16. The pothole spray patcher as claimed in claim 15, wherein the processor is further configured to—
operate the first material conveying device to supply a flow rate of first spray patching material associated with the recorded flow rate of first spray patching material; and
operate the second material conveying device to supply a flow rate of second spray patching material associated with the calculated flow rate of second spray patching material.

17. The pothole spray patcher vehicle as claimed in claim 16, wherein the processor is further configured to—
determine a measured flow rate of the supplied flow of second spray patching material; and
adjust operation of the second material conveying device to reduce any difference between the calculated flow rate and the measured flow rate.

18. The pothole spray patcher vehicle as claimed in claim 17,
said second material conveying device including a motor,
said step of adjusting operation of the second material conveying device including the step of increasing the motor rotational speed and/or the step of decreasing the motor rotational speed.

19. The pothole spray patcher vehicle as claimed in claim 17, wherein the processor is further configured to—
compare the calculated flow rate of the second spray patching material and the measured flow rate of the provided second spray patching material.

20. The pothole spray patcher vehicle as claimed in claim 15,
said first material conveying device including a first motor and said second material conveying device including a second motor.

21. The pothole spray patcher vehicle as claimed in claim 20,
said first material conveying device including an auger operably powered by the first motor, with the spray patching material comprising an aggregate material configured to be conveyed by the auger,
said second material conveying device including a pump operably powered by the second motor, with the another spray patching material comprising an emulsion material configured to be conveyed by the pump.

22. A pothole patcher vehicle configured to supply a desired ratio of dispensed patching materials, said pothole patcher vehicle comprising:
a first material conveying device operable to supply a flow of first patching material;
a second material conveying device operable to supply a flow of second patching material; and
a processor being operably coupled to the material conveying devices and configured to—
record a flow rate of the first patching material set by the user;
record a flow rate of the second patching material as set by the user or as determined by calculating the flow rate of the second patching material based upon the recorded first patching material flow rate and a recorded ratio set by the user;
operate the first material conveying device to supply a flow rate of first patching material associated with the recorded flow rate of first patching material; and
operate the second material conveying device to supply a flow rate of second patching material associated with the recorded flow rate of second patching material.

23. The pothole patcher vehicle as claimed in claim 22, wherein the processor is further configured to—
determine a measured flow rate of the supplied flow of second patching material; and
adjust operation of the second material conveying device to reduce any difference between the calculated flow rate and the measured flow rate.

24. The pothole patcher vehicle as claimed in claim 23,
said second material conveying device including a motor,
said step of adjusting operation of the second material conveying device including the step of increasing the motor rotational speed and/or the step of decreasing the motor rotational speed.

25. The pothole patcher vehicle as claimed in claim 23, wherein the processor is further configured to—
compare the recorded flow rate of the second patching material and the measured flow rate of the supplied second patching material.

26. The pothole patcher vehicle as claimed in claim 22,
said first material conveying device including a first motor and said second material conveying device including a second motor.

27. The pothole patcher vehicle as claimed in claim 26,
said first material conveying device including an auger operably powered by the first motor, with the patching material comprising an aggregate material configured to be conveyed by the auger,
said second material conveying device including a pump operably powered by the second motor, with the another patching material comprising an emulsion material configured to be conveyed by the pump.
